(19) United States
(12) Patent Application Publication
(10) Pub. No.: US 2020/0097891 A1
(43) Pub. Date: Mar. 26, 2020

(54) DEALER INVENTORY MANAGEMENT APPLICATION AND METHOD

(71) Applicant: Arnel Patag, Brampton (CA)

(72) Inventor: Arnel Patag, Brampton (CA)

(21) Appl. No.: 16/136,838

(22) Filed: Sep. 20, 2018

(51) Int. Cl. G06Q 10/08; G06Q 40/02; G07C 5/00; H04W 4/021; G06K 9/00; G10L 17/00; G06K 7/14

(52) U.S. Cl. CPC G06Q 10/087; G06Q 40/025; G07C 5/008; G06K 7/1404; G06K 9/00288; G10L 17/005; H04W 4/021

(57) ABSTRACT

An audit software application that will operate under iOS and android platforms. The App is design for internal auditors, dealer's self-service and global market with the capabilities to perform dealer floorplan audit for physical audit, physical sampling, book audit and/or payment testing and takeover audit. The software application is designed to create efficiency.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of inventory management of existing art and more specifically relates to a dealer vehicle inventory management application (floorplan inventory audit & dealer self service).

### RELATED ART

In modern society many individuals drive vehicles. Many of these vehicles are purchased at various locations across the country such as at dealerships. Dealerships may be supplied by factories. The dealerships need to keep accurate vehicle inventories, but this has proven difficult with conventional methods. A suitable solution is desired.

U.S. Pat. No. 8,533,073 to Cameron Eldred relates to an electronically implemented floorplan auditing system and method. The described electronically implemented floorplan auditing system and method includes an electronic method of auditing floorplan loans. The floorplan loans are provided by a lending source to a plurality of vehicle dealers. The method includes, for each of the plurality of vehicle dealers, an entity other than the lending source or a dealer (i) retrieving the lending source's records corresponding to the dealer's floorplan loan; (ii) retrieving the dealer's internal financial records used by the dealer for tracking sales; (iii) comparing the lending source's records with the dealer's internal financial management records to determine a variance between the lending source's records and the dealer's records; and (iv) reporting the variance to the lending source

### SUMMARY OF THE INVENTION

In view of the foregoing disadvantages inherent in the known inventory management art, the present disclosure provides a novel dealer vehicle inventory management application. The general purpose of the present disclosure, which will be described subsequently in greater detail, is to provide an efficient and effective floorplan inventory audit & dealer self service through a digital process.

A dealer vehicle inventory management system is disclosed herein comprising: a server including: a processor, and a memory in communication with the processor, the memory having: a database comprising at least data related to inventory vehicles referenced to vehicle identification numbers that is suitable for inventory management and dealer self-service-audit, and a device capable of accessing GPS and including a user-interface configured to enable communication with the server via a software application.

A method of use for a dealer vehicle inventory management system is also disclosed herein; the method comprising the steps of: providing a dealer inventory management system, and performing a dealer floorplan audit for physical audit, physical sampling, book audit and/or payment testing and takeover audit; wherein the dealer inventory management system comprises a software application.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a dealer inventory management system and application, constructed and operative according to the teachings of the present disclosure.

FIG. 1 is a perspective view of the dealer vehicle inventory management application during an ‘in-use’ condition, according to an embodiment of the disclosure.

FIG. 2 is a view of the dealer vehicle inventory management application of FIG. 1, according to an embodiment of the present disclosure.

FIG. 3 is a view of the dealer vehicle inventory management application of FIG. 1, according to an embodiment of the present disclosure.

FIG. 4 is a view of the dealer vehicle inventory management application of FIG. 1, according to an embodiment of the present disclosure.

FIG. 5 is a flow diagram illustrating a method of use for the dealer vehicle inventory management application, according to an embodiment of the present disclosure.

FIG. 6 is a view of the dealer vehicle inventory management application of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to inventory management and more particularly to a dealer vehicle inventory management application as a system used to improve the floorplan inventory audit & dealer self-service means for vehicles.

Generally speaking the present invention comprises an audit software application that will operate on iOS and android platforms. The App is design for internal auditors, dealer's self-service and global market with the capabilities to schedule and perform dealer floorplan audit for physical audit, physical sampling, book audit and/or payment testing, body builder (commercial vehicles) and takeover audit based on dealer frequency requirements. The application improves cost performance to service the wholesale portfolio, reduce vendor time and cost, improve data accuracy and reporting of audit results through digital process, and utilize telematics data. It accomplishes the end goal of remote auditing and self-service audit with authorized dealers and meets global floorplan audit demands.

In addition, the present invention serves to: 1. The App has capability to process physical inventory utilizing manual entry of VIN, Voice recognition, barcode scanning, VIN reader to text via photo; 2. The Application has a capability to record latitude and longitude (geotagging) individual car or truck on its physical location on the ground utilizing in built GPS technology from the mobile device; 3. Dealer capability to use the application for inventory management and Dealer self-service audit; 4. App will have capability to receive telematics data from its factory inbuilt communication for Cars and Trucks. Car receives its GPS datapoints from MB telematics (Hermes module) using (In or Out) geofencing method or report latitudes and longitudes. Trucks will report Latitude and Longitude; 5. Ability to capture and attach relevant audit documentation required based on disposition code via photo; 6. Capability to perform audit with multiple users on the same audit on dealer with multiple locations; 7. Auto and manual audit Data sync from multiple device source; 8. Electronic signature capability; 9. Electronic reporting of final audit results; 10. The application is designed to deliver audit results from Physical Audit, Physical Sampling, Book Audit or Payment Testing, Body Builder, and Takeover Audit for internal auditor.; 11. Dealer can use the App for Dealer Self-Service with functionality for inventory management and Self Audit to be completed based on assigned dealer frequency; 12. Capability to transpose the App anywhere the inventory is located; 13. The Application will be available globally and configurable to meet specific county demands. The application may also operate in an offline mode to enable auditing with existing data.

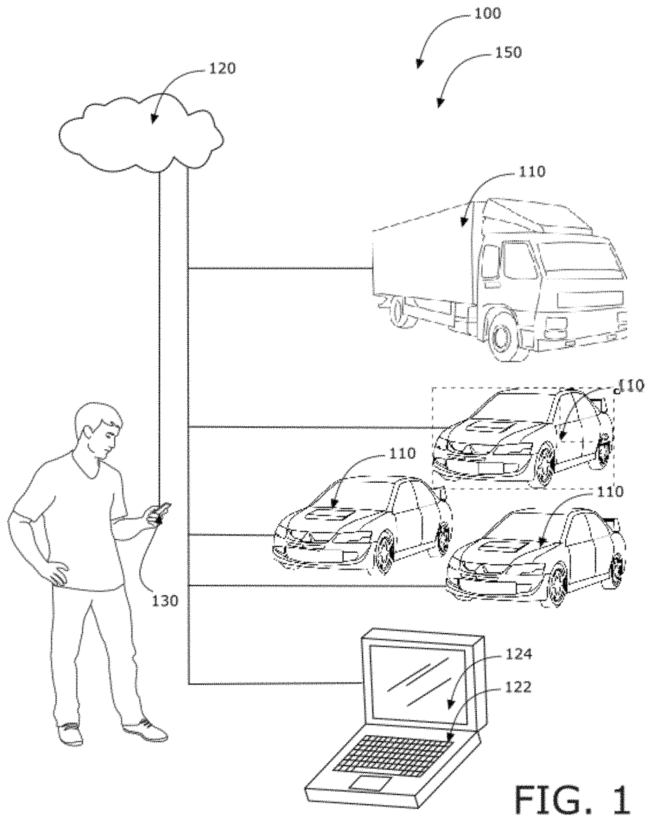

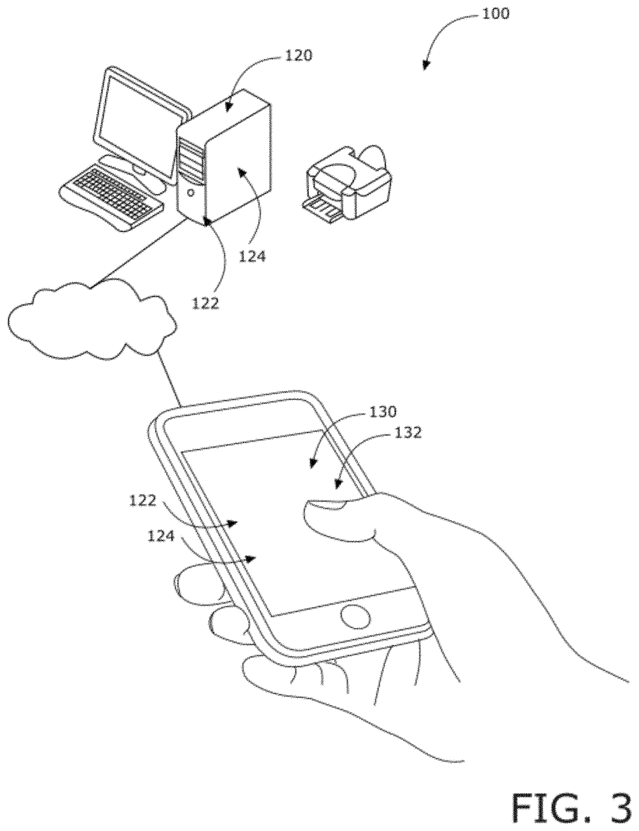

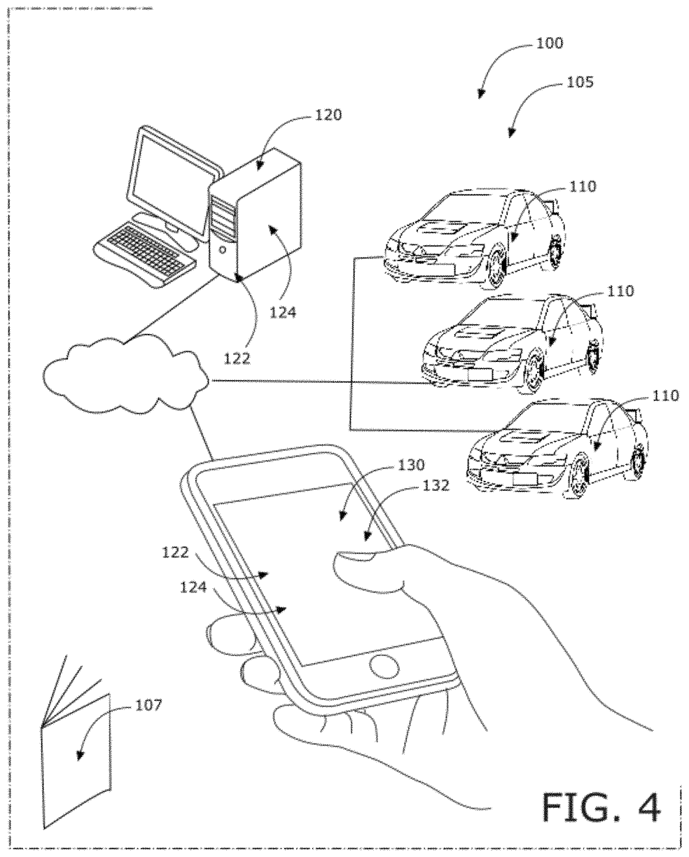

Referring now more specifically to the drawings by numerals of reference, there is shown in FIGS. 1-4, various views of a dealer vehicle inventory management system 100.

FIG. 1 shows a dealer vehicle inventory management system 100 during an ‘in-use’ condition 50, according to an embodiment of the present disclosure. Here, the dealer vehicle inventory management system 100 may be beneficial for use by a user to accurately inventory vehicles 110. As illustrated, the dealer inventory management system 100 may include a server 120 including: a processor 122, and a memory 124 in communication with the processor 122, the memory 124 having: a database comprising at least data related to inventory vehicles 110 referenced to corresponding vehicle identification numbers that is suitable for inventory management and dealer self-service-audit, and a device 130 capable of accessing GPS and including a user-interface configured to enable communication with the server 120 via a software application 132.

According to one embodiment, the dealer vehicle inventory management system 100 may be arranged as a kit 105. In particular, the dealer inventory management system 100 may further include a set of instructions 107. The instructions 107 may detail functional relationships in relation to the structure of the dealer inventory management system 100 such that the dealer inventory management system 100 can be used, maintained, or the like, in a preferred manner.

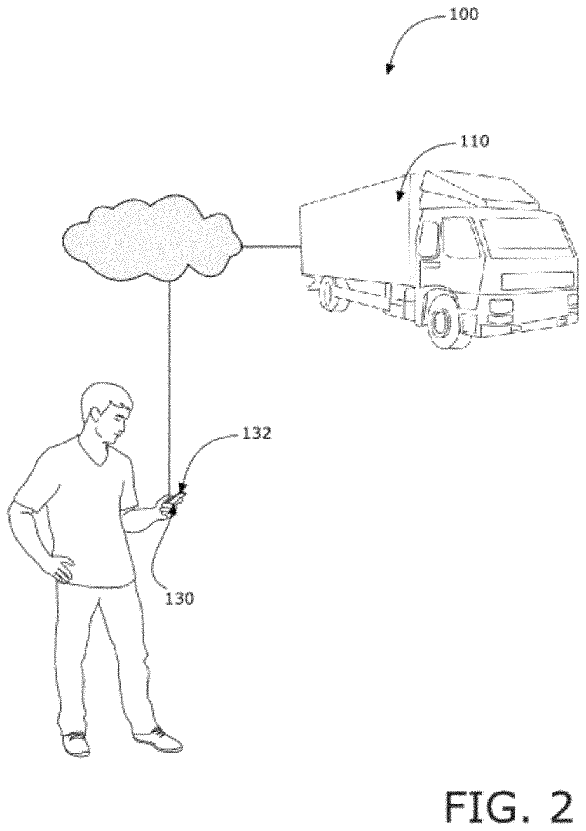

FIGS. 2-4 show the dealer vehicle inventory management system 100 of FIG. 1, according to an embodiment of the present disclosure. As above, the software application 132 of the dealer inventory management system 100 may comprise the capability to process physical inventory using manual entry of the vehicle identification numbers. The software application 132 comprises voice recognition and uses barcode scanning. The software application 132 is capable of reading the vehicle identification numbers and the device 130 is able to send a text via photo. Further, the software application 132 has capability to record latitude and longitude as geotagging of the individual vehicle 110 in its unique physical location based on reading of the GPS by the mobile device 130. The mobile device 130 may comprise a smartphone (cellular) or other suitable electronic device such as a tablet or the like.

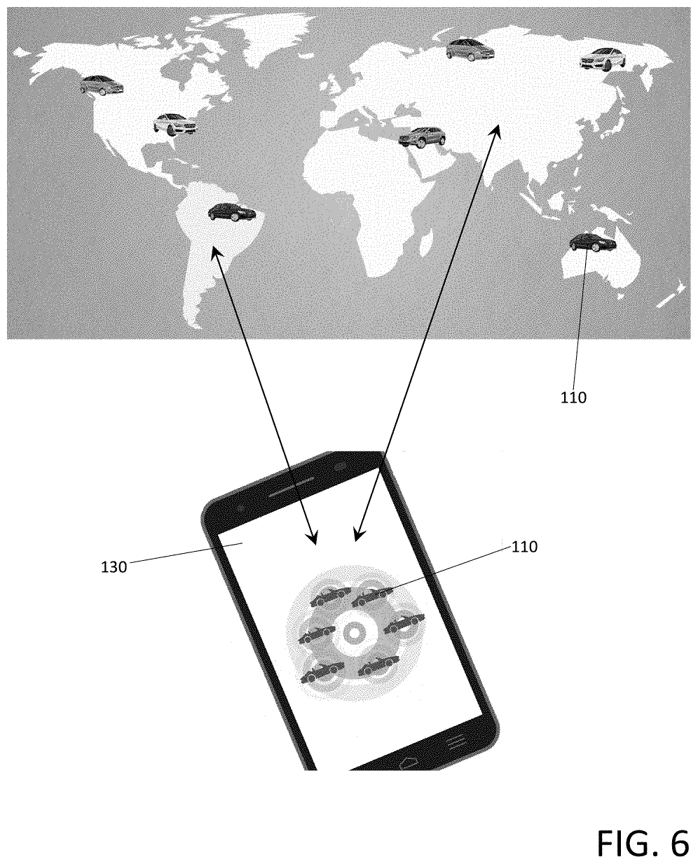

The mobile device 130 via the software application 132 has capability to receive telematics data from its factory inbuilt communication for the vehicles 110. The vehicle 110 receives its GPS datapoints from MB telematics (Hermes system); wherein the GPS datapoints received from the MB telematics is/are preferably via geofencing. When the vehicle 110 comprises a truck, the truck reports the latitude and longitude. Alternatively, other vehicles may also report latitude and longitude. GPS and latitude/longitude reporting is further illustrated in FIG. 6.

Further, the mobile device 130 via the software application 132 has capability to capture and attach relevant audit documentation required based on disposition code via photo and is able to perform at least one audit with multiple users on the same the at least one audit on dealer with multiple locations. For example, the disposition codes may include 1-found; 2-sold; 3-dealer trade; 4-demo found; 5-demo out; 6-found, not on floor plan; 7-body builder; 8-out; 9-loaners; 10-consignment unit; 11-stolen; 12-fleet sales; 13-assignment of proceeds. Other codes may be included or codes may be omitted, depending on the audit requirements. The disposition codes may then be used to generate dynamic reports according to one or more selected disposition codes.

The mobile device 130 of the vehicle dealer inventory management system 100 via the software application 132 has capability to perform manual and auto audits via data sync from multiple-device-sources. The mobile device 130 via the software application 132 has electronic-signature-capability and the software application 132 generates final-audit-results. As designed, the software application 132 is able to be set at an assigned dealer frequency. Those with ordinary skill in the art will now appreciate that upon reading this specification and by their understanding the art of inventorying, communication between devices as described herein, methods of communication and tracking will be understood by those knowledgeable in such art.

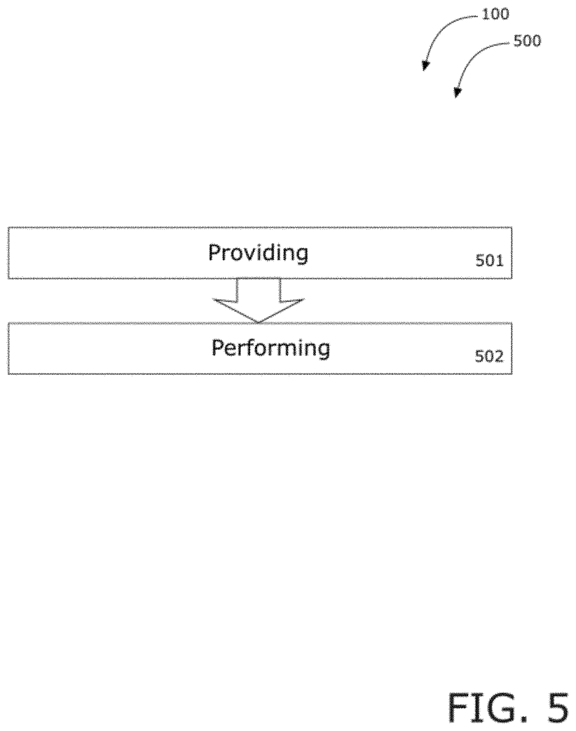

FIG. 5 is a flow diagram illustrating a method for use 500 of the dealer inventory management system 100, according to an embodiment of the present disclosure. In particular, the method of use 500 may include one or more components or features of the dealer inventory management system 100 as described above. As illustrated, the method for use 500 may include the steps of: step one 501, providing (dealer names, address, inventory information, inventory locations (GPS), dealer frequency; separate data feeds with telematics and without telematics; dealer audit configuration, photo requirements, sample size selections; audit scheduling) a dealer inventory management system 100; step two 502, performing a dealer floorplan audit for physical audit, physical sampling, book audit and/or payment testing, body builder, and takeover audit; wherein the dealer inventory management system 100 comprises a software application 132.

The system may further be capable of operating in an offline mode, in situations and areas where communication with remote data sources may not be possible.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for dealer inventory management system 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A dealer vehicle inventory management system comprising:
a server including:
a processor; and
a memory in communication with the processor, the memory having:
a database comprising at least data related to inventory vehicles referenced to vehicle identification numbers that is suitable for inventory management and dealer self-service-audit; and
a device capable of accessing GPS and including:
a user-interface configured to enable remote communication with the server via a software application and to enable remote auditing of vehicles.

2. The dealer vehicle inventory management system of claim 1, wherein said software application has capability to process physical inventory using manual entry of said vehicle identification numbers.

3. The dealer vehicle inventory management system of claim 1, wherein said software application comprises one or more of: voice recognition, barcode scanning, QR code scanning and facial recognition.

4. The dealer vehicle inventory management system of claim 2, wherein said software application is capable of reading said vehicle identification numbers and said device able to send a text via photo.

5. The dealer vehicle inventory management system of claim 1, wherein the software application has capability to take a photo and record latitude and longitude as geotagging of individual said vehicle on its unique physical location based on reading of said GPS by the mobile device.

6. The dealer vehicle inventory management system of claim 1, wherein the mobile device via the software application has capability to receive telematics data from its factory inbuilt communication for said vehicles, the telematics data including one or more of: vehicle mileage, vehicle color, and vehicle specifications.

7. The dealer vehicle inventory management system of claim 7, wherein the vehicle receives its GPS datapoints from MB telematics (Hermes).

8. The dealer vehicle inventory management system of claim 1, wherein the GPS datapoints received from the MB telematics is via geofencing or an in and out model.

9. The dealer vehicle inventory management system of claim 1, wherein when the vehicle comprises a truck, said truck reports said latitude and longitude.

10. The dealer vehicle inventory management system of claim 1, wherein the mobile device via the software application has capability to capture and attach relevant audit documentation required based on disposition code via photo.

11. The dealer vehicle inventory management system of claim 1, wherein the mobile device via the software application has capability to perform at least one audit with multiple users on the same said at least one audit on dealer with multiple locations.

12. The dealer vehicle inventory management system of claim 1, wherein the mobile device via the software application has capability to perform manual and auto audits via data sync from multiple-device-sources.

13. The dealer vehicle inventory management system of claim 1, wherein the mobile device via the software application has electronic-signature-capability.

14. The dealer vehicle inventory management system of claim 1, wherein the software application generates final-audit-results.

15. The dealer vehicle inventory management system of claim 1, wherein the software application is capable of producing dynamic reports based on one or more disposition codes.

16. The dealer vehicle inventory management system of claim 1, wherein the software application is capable of operating in an offline mode.

17. A dealer vehicle inventory management system comprising:
a server including:
a processor; and
a memory in communication with the processor, the memory having:
a database comprising at least data related to inventory vehicles referenced to vehicle identification numbers that is suitable for inventory management and dealer self-service-audit; and
a device capable of accessing GPS and including:
a user-interface configured to enable remote communication with the server via a software application and to enable remote auditing of vehicles;
wherein said software application has capability to process physical inventory using manual entry of said vehicle identification numbers;
wherein said software application comprises voice recognition and barcode scanning;
wherein said software application is capable of reading said vehicle identification numbers and said device able to send a text via photo;
wherein the software application has capability to take a photo and record latitude and longitude as geotagging of individual said vehicle on its unique physical location based on reading of said GPS by the mobile device;
wherein the mobile device via the software application has capability to receive telematics data from its factory inbuilt communication for said vehicles;
wherein the vehicle receives its GPS datapoints from MB telematics (Hermes);
wherein the GPS datapoints received from the MB telematics is via geofencing; and
wherein the mobile device via the software application has capability to capture and attach relevant audit documentation required based on disposition code via photo.

18. The dealer vehicle inventory management system of claim 17, further comprising set of instructions; and
wherein the dealer inventory management system is arranged as a kit.

19. A method of use for a dealer vehicle inventory management system, the method comprising the steps of:
providing a dealer inventory management system to enable remote auditing of vehicles; and
performing a dealer floorplan audit for physical audit, physical sampling, book audit and/or payment testing, body builder, and takeover audit.

20. The method of claim 19, wherein said dealer inventory management system comprises a software application.
